(19) United States
(12) Patent Application Publication
(10) Pub. No.: US 2023/0308294 A1
(43) Pub. Date: Sep. 28, 2023

(54) PUBLIC KEY AUTHENTICATION DEVICE AND PUBLIC KEY AUTHENTICATION METHOD

(71) Applicant: Nippon Telegraph and Telephone Corporation, Tokyo (JP)

(72) Inventor: Hiromu AOSHIMA, Musashino-shi, Tokyo (JP)

(21) Appl. No.: 18/023,064

(22) PCT Filed: Aug. 26, 2020
(86) PCT No.: PCT/JP2020/032092

§ 371 Date: Feb. 24, 2023

(51) Int. Cl. H04L 9/32; H04L 9/08; H04L 9/00

(52) U.S. Cl. CPC H04L 9/3268; H04L 9/0825; H04L 9/006

(57) ABSTRACT

The SIP telephone public key authentication device (20) stores a private key, a public key and a public key certificate of a calling party related to a A telephone (30) using the SIP in a secret area of the IC card (31). A SIP application (30b) transmits the URI of the calling party, and the public key and the public key certificate read from the secret area to the PKI server (22). A PKI server (22) generates a random number when the public key certificate answers that the public key certificate is valid from a certificate authority (50). The SIP application (30b) allows each of the random number and the URI to sign with a secret key in a secret area of the IC card (31), and transmits a signature result to the PKI server (22) together with the public key and the public key certificate. The PKI server (22) verifies the public key certificate using the public key to authenticate the calling party.

### TECHNICAL FIELD

The present invention relates to a public key authentication device and a public key authentication method that enable personal authentication of a calling party by applying a public key authentication technique to a telephone system that uses a voice call on an IP (Internet Protocol) network.

### BACKGROUND ART

When making a voice call on the Internet, a SIP (Session Initiation Protocol) protocol is applied to control calls such as outgoing/incoming calls and answers. In telephones using this SIP (hereinafter referred to as SIP telephones), highly expandable telephone functions have been realized due to the spread of IP and the sophistication of networks.

In a SIP telephone, a user has a URI (Uniform Resource Identifier) as information corresponding to a telephone number. The URI is information corresponding to the telephone number of the SIP telephone. The URI is a form of textual information, for example, such as an email address such as “UserD@west.net”, “+81-11-123-4567@west.net”, “UserD@10.11.12.13”, etc., and has the feature that it can be freely set and sent only by URI. In addition, the URI is transmitted together with the telephone number when the call is made by the telephone number on the SIP telephone.

However, since a third party can misuse the transmission using only URI, there is a technique for performing personal authentication by RSA signature using RSA (Rivest Shamir Adleman cryptosystem) encryption described later. RSA cryptography is one of public key cryptosystems, and is used for personal authentication such as signing an electronic document with a private key and verifying this signature with a public key. For example, the public personal identification service installed in Japanese personal number cards is realized by RSA encryption.

In order to realize such an authentication technique for individual users of SIP telephones, the SIP telephone with a personal authentication function (NPL 1) that combines the SIP and the public key authentication has been proposed.

### CITATION LIST

### Non Patent Literature

[NPL 1] Hirotake Aoshima, “A Study on the Use of Public Personal Authentication Service in the SIP Telephone System”, IEICE General Conference 2020, D-19-2, March 2020.

### SUMMARY OF INVENTION

### Technical Problem

It is known that the above-mentioned RSA signature has a vulnerability that an attacker (third party) who only receives information sent by SIP succeeds in an attack when the sender can freely decide the signature object.

To avoid this vulnerability, there is a method to authenticate the calling party before making a call to connect with the other party. However, as a constraint condition, it is assumed that contents that are different than usual (additional information) are not added to the signal at the time of SIP transmission, in other words, SIP is not expanded. In order to authenticate the calling party before the call without extending the SIP, there is a method of associating the URI of the calling party with the authentication information that can identify who the calling party is.

However, if the method of linking the sender's URI and the authentication information is inappropriate, there is a problem that spoofing becomes possible. For example, the attacker can steal the sender's authentication information, the attacker can replace the URI, and the replaced URI can be used to impersonate the calling party himself/herself.

The present invention has been made in view of such circumstances, and it is an object of authenticating the calling party individual by properly links the calling party's URI and the calling party's authentication information after making a call using the URI on the SIP telephone and before making a call to connect with the other party.

### Solution to Problem

A public key authentication device for solving above described the problem, a public key authentication device comprising: an IC card for storing, in a secret area, a secret key, a public key and a public key certificate of a calling party related to a calling party telephone using SIP (Session Initiation Protocol) generated by a certificate authority that authenticates a secret key, a public key and a public key certificate; a SIP application for receiving an instruction from the calling party to determine a URI (Uniform Resource Identifier) of the calling party and causing the calling party telephone to execute control of transmitting a determined URI, a public key and a public key certificate read from the IC card; and a PKI (Public Key Infrastructure) server for receiving a public key and a public key certificate from the calling party telephone, generates a random number when a result of inquiry of validity of the public key certificate to the certificate authority is valid as answer, and authenticates the calling party after transmitting a generated random number to the calling party telephone, wherein the SIP application executes a signature calculation for causing each of a random number from the PKI server and the determined URI to sign with a secret key in a secret area of the IC card, transmits a signature result obtained by the execution to the PKI server together with a public key and a public key certificate read from the secret area, and the PKI server verifies the public key certificate by using the public key among a received signature result, a public key and a public key certificate, and authenticates a calling party.

### Advantageous Effects of Invention

According to the present invention, it is possible to authenticate an individual calling party by appropriately linking the calling party's URI and the calling party's authentication information after making a call using the URI on the SIP telephone and before making a call to connect with the other party.

### BRIEF DESCRIPTION OF DRAWINGS

FIG. 1 is a block diagram showing the configuration of a SIP telephony public key authentication system using a SIP telephony public key authentication device.

FIG. 2 is a diagram showing a storage table configuration of a DB of an authentication result recording server.

FIG. 3 is a first sequence diagram for explaining SIP telephone public key authentication operation in a SIP telephone public key authentication system according to the present embodiment.

FIG. 4 is a second sequence diagram for explaining SIP telephone public key authentication operation in the SIP telephone public key authentication system according to the present embodiment.

### DESCRIPTION OF EMBODIMENTS

Hereinafter, embodiments of the present invention will be described with reference to the drawings. However, the same reference signs are given to the components corresponding to the functions in all the drawings of the present specification, and the description thereof will be omitted as appropriate.

### Structure of Embodiment

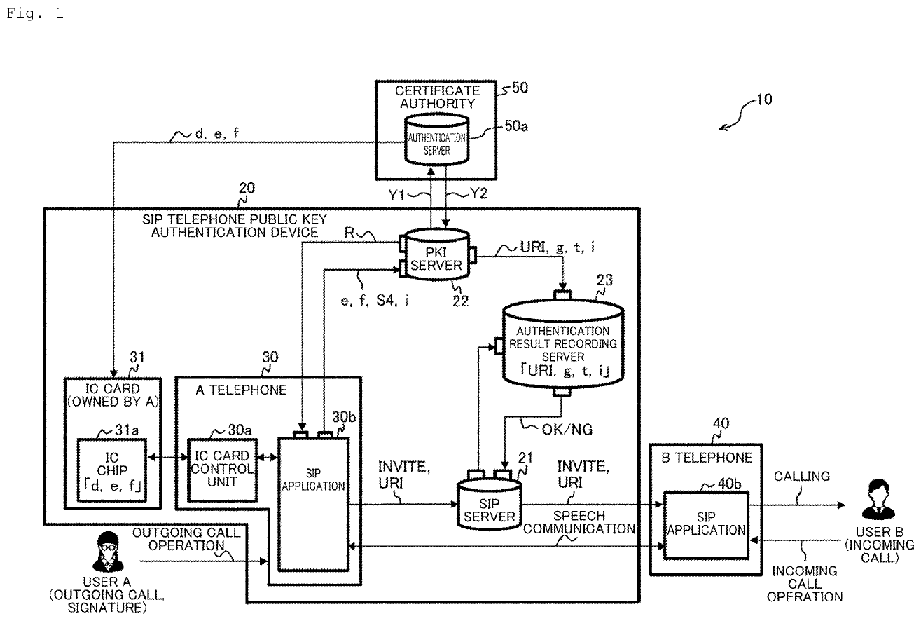

FIG. 1 is a block diagram showing a configuration of a SIP telephone public key authentication system using the SIP telephone public key authentication device according to the embodiment of the present invention.

The SIP telephone public key authentication system (also referred to as a system or public key authentication system) 10 shown in FIG. 1 includes the SIP telephone public key authentication device (also referred to as an authentication device) 20 and an A telephone 30 owned by a user A (also referred to as a calling party A), a B telephone 40 owned by user B (also referred to as a called party B), an IC (Integrated Circuit) card 31 owned by a user A, and a certificate authority 50. The A telephone 30 constitutes the calling party telephone described in the claims. The B telephone 40 constitutes the called party telephone described in the claims. The SIP telephone public key authentication device 20 constitutes the public key authentication device described in the claims.

The certificate authority 50 is a reliable third party organization that generates the public key e and the private key d, and manages the generation and retention of the public key certificate f. The public key certificate f is information that the certificate authority 50 has authenticated that the public key e is correct. The certificate authority 50 authenticates the validity of the public key certificate f by the authentication server 50a. Only the certificate authority 50 has the authentication information for performing this authentication, and it is kept confidential only in the authentication server 50a.

The A telephone 30 is a SIP telephone, which makes a call with the B telephone 40 via the authentication device 20, and includes an IC card control unit 30a and a SIP application (SIP application software) 30b.

The IC card control unit 30a has an RFID (Radio Frequency Identification) function, the IC card 31 is in contact with (or is close to) the IC card reading portion of the A telephone 30, and a predetermined password number assigned from the A telephone 30 is input, and then each information recorded on the IC chip 31a as a secret area of the IC card 31 is read or the information is written.

The IC chip 31a stores and stores each information of the private key d of the user A, the public key e for public key authentication, and the public key certificate f authenticated by the certificate authority 50. However, the private key d is stored in the IC chip 31a as a secret area. The private key d may be stored in a place other than the IC chip 31a of the IC card 31 as long as it can be safely stored. In the public key certificate f, the serial number of the user A who has received the signature of the certificate authority 50 (certificate authority signature) and the public key e are recorded.

The IC card 31 is supposed to use a public personal authentication service (JPKI: Japanese Public Key Infrastructure) and a personal number card in Japan, even if the IC card 31 is related to a public key infrastructure (PKI: Public Key Infrastructure), anything may be also fine. As long as the IC card 31 is possessed, the person to be certified may be an individual, a corporation, an administrative agency, or any other organization.

The SIP application 30b is software on the calling party A side that makes a SIP phone (A telephone 30), and also executes an authentication flow operation before making a call. The authentication flow operation receives a random number R from the PKI server 22, and calculates a value to be signed by appropriately combining the received random number R and the URI of the calling party A (also referred to as the URI of A).

Further, the signature using the private key d is performed by the IC chip 31a of the IC card 31. The SIP application 30b causes the IC chip 31a to sign via the IC card control unit 30a, receives the value of the signature result by this signature (referred to as the signature result S4), and transmits the signature result S4 to the PKI server 22. At this time, the public key e and the public key certificate f are also transmitted at the same time. After that, the SIP application 30b makes a call to the SIP telephone (A telephone 30) after receiving the notification of the completion of verification from the PKI server 22. The outgoing call itself of the SIP phone is the same as the general outgoing call.

The SIP telephone public key authentication device 20 performs personal authentication processing of the calling party A, and includes a SIP of the SIP server 21, the PKI server 22, the authentication result recording server (also referred to as a recording server) 23, and the application 30b of the A telephone 30 and the IC chip 31a of the IC card 31.

The PKI server 22 is a server that authenticates the calling party A using the public key cryptographic infrastructure described above, and generates a random number R, and transmits the random number R to the calling party A's A telephone 30 as follows. That is, the PKI server 22 inquires of the authentication server 50a about the validity of the public key e and the public key certificate f of the calling party A received from the SIP application 30b as indicated by the arrow Y1, and in response to this inquiry, the authentication server 50a Confirm the validity answer returned from as indicated by the arrow Y2. If the answer indicates the validity of the public key certificate f by this confirmation, the PKI server 22 generates the above-mentioned random number R and sends it to the A telephone 30.

The SIP application 30b of the telephone 30 A processes each of the random number R and the URI of the calling party A so as to sign with the private key d in the IC chip 31a (signature calculation described later). By signing each (two) of the random numbers R and the URI with the private key d as in this process, the mechanism is such that only the calling party A who knows the private key d can properly sign. In addition to this, the private key d is stored in a secure IC chip 31a that cannot be read by a third party. Therefore, strong security is ensured so that the private key d cannot be stolen.

Further, the PKI server 22 receives the signature result S4 obtained by the signature calculation (described later) in the SIP application 30b together with the public key e and the public key certificate f, receives the public key certificate f by the public key e of the calling party A, and verifies with and authenticate calling party A. Here, if the PKI server 22 verifies the signature result S4 and determines that the signature is the signature of the calling party A, the authentication result i is OK (valid), and otherwise it is NG (No Good). Even if the authentication result i is OK, the authentication result i becomes invalid after a certain time has passed from the time of authentication.

However, the signature processing (signature calculation) by the IC chip 31a of the SIP application 30b and the IC card 31 and the verification processing (verification calculation) of the signature result S4 by the PKI server 22 described above are the three types of signature methods a, which will be described later. It is designed to apply b and c. The three types of signature methods a, b, and c mean that there are three types of RSA signature methods, a, b, and c.

The RSA signature is a signature using a public key cryptosystem called RSA cryptography. In this example, authentication is performed using the RSA signature. The private key d and public key e used for RSA signature are numbers. Assuming that a certain number of m is the signature object, the signature calculation in RSA signature is an operation for finding σ: =m^{d} mod n that the number of the remainder obtained by multiplying the signature object m by the private key d-th power (d-square of m) and dividing the number of m^{d} by the parameter n. This operation is called a signature calculation. The parameter n is a number defined in the RSA cryptographic framework.

The signature result above is a set (m, σ) of the original number m and the result a of the signature calculation above. The signature calculation is sometimes called a signature.

The verification calculation above (inverse calculation of signature calculation) is a calculation that obtains the number (σ^{e}) of the number a of signature result raised to the power by the public key e, and obtains the number the remainder number m′: =σ^{e} mod n dividing the number (σ^{e}) by n. The verification is to check whether m′ and m are equal, if they are equal, the authentication result is OK, and if they are not equal, the authentication result is NG.

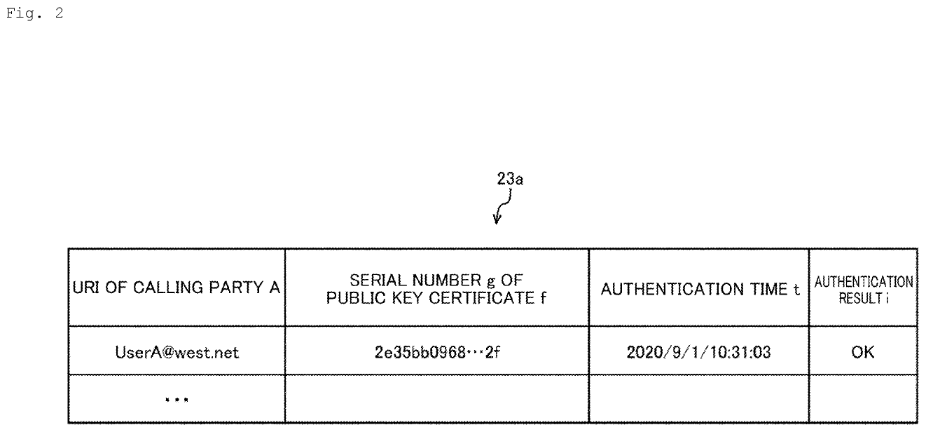

The authentication result recording server (also referred to as a recording server) 23 stores the URI, the serial number g of the public key certificate f, the authentication time t, and the authentication result i transmitted from the PKI server 22. For example, as shown in FIG. 2, in the DB (Data Base) 23a of the recording server 23, the calling party A's URI “UserA@west.net” and the public key certificate f serial number g “2e35bb0968 . . . 2f”, “2020/9/1/10: 31: 03” of the authentication time t, and “OK” of the authentication result i are memorized and stored.

The SIP server 21 has a call function between the A telephone 30 using the SIP and the B telephone 40, and records and searches for a telephone number, an IP address, and the like, and manages an IP telephone service.

The SIP server 21 transmits INVITE (described later) or the URI of A to the SIP server 21. INVITE is the first protocol information sent by SIP to establish a session.

The B telephone 40 is the SIP telephone including the SIP application 40a. The B telephone 40 may be a telephone of a model other than the SIP telephone, and the equipment from the switch to the B telephone 40 may be a telephone that can be used as the analog telephone equipment of the metal line.

<Signature Methods a, b, c>

Next, the above-mentioned three types of signature methods a, b, and c will be described.

As described above, when the random number R generated by the PKI server 22 is returned to the A telephone 30, the SIP application 30b cooperates with the IC chip 31a of the IC card 31 to sign. The authentication result i obtained by this signature is verified by the PKI server 22. This signature and verification process is performed by any one of the signature methods a, b, and c.

Here, S1 quoted in the formula described later is a signature object, S2 is a signature object value, S3 is a signature calculation result, and S4 is a signature result. Further, e is the public key of the calling party A, d is the private key of the calling party A, R is a random number generated by the PKI server 22, U is the URI of the calling party A, and h is the hash function.

<Signing Method a>

S1=h(U) (1)

S2=h(U),R (2)

S3=σ_{h(U)},σ_{R} (3)

S4=(U,σ_{h(U)},σ_{R}) (4)

The above equation (1) represents that the SIP application 30b inputs the URI of A into the hash function h and calculates the signature object S1. That is, at first, since there is only the URI of A, the calculation is performed by the hash function h.

Next, the SIP application 30b calculates the signature object value S2 from each of the h (U) calculated by the above equation (1) and the random number R received from the PKI server 22 according to the above equation (2). The signature object value S2 based on the calculated h (U) and R is transmitted to the IC chip 31a.

Next, the IC chip 31a performs the calculation of the above equation (3) according to the control of the SIP application 30b to obtain the signature calculation result S3.

At this time, the σ_{h (U)} of the equation (3) is obtained from the following equation (3a), and the σ_{R} of the equation (3) is obtained from the following equation (3b).

σ_{h(U)}:={h(U)}^{d} mod n (3a)

σ_{R}:=R^{d} mod n (3b)</569>

That is, the signature calculation result S3 is defined as the remainder σ_{h (U)} obtained by dividing the d-th power of h (U) by the above equation (3a) by the parameter n and the remainder σ_{R} obtained by dividing the d-th power of R according to the above equation (3b) by the parameter n. The signature calculation result S3 has two, σ_{h (U)} and σ_{R}, and is transmitted to the SIP application 30b.

Next, the SIP application 30b performs the calculation of the above equation (4) to obtain the signature result S4.

That is, the signature result S4 is obtained as a pair (U, σ_{h(U)}, σ_{R}) of three values: the URI of calling party A, the result of the first signature calculation result σ_{h(U)}, and the result of the second signature calculation result σ_{R}. The signature result S4 is returned to the PKI server 22 as a response.

Next, the PKI server 22 verifies the signature result S4. That is, the PKI server 22 receives the set of signature results S4 (U, σ_{h (U)}, σ_{R}), and calculates {σ_{h (U)}}^{e} and σ_{R}^{e}, and the signature of the calling party A himself/herself is verified when it is satisfied with the following equations (4a) and (4b).

h(U)≡{σ_{h(U)}}^{e} mod n (4a)

σ_{R}^{e}≡R mod n (4b)

In {σ_{h (U)}}^{e} of the above equation (4a) and σ_{R}^{e} of the above equation (4b), the e of the e-th power is the public key e of the calling party A, and the public key e is the multiplier (power number). This also applies to other equations described later.

That is, it is verified that signature is signed by the calling party A himself/herself, if h (U) in the above equation (4a) is equal to the remainder obtained by dividing {σ_{h (U)}}^{e} by n, and σ_{R}^{e} in the above equation (4b) is equal to the remainder obtained to divide the random number R by the parameter n.

<Signing Method b>

S1=h(R+U) (11)

S2=h(R+U) (12)

S3=σ_{h(R+U)},σ_{R} (13)

S4=(U,σ_{h(R+U)}) (14)

The above equation (11) or (12) is a signature object S1 or a signature object value S2 calculated by the SIP application 30b by inputting the sum of the random numbers R and the URI of A into the hash function h. The signature object value S2 is transmitted to the IC chip 31a.

Next, the IC chip 31a performs the calculation of the above equation (13) according to the control of the SIP application 30b to obtain the signature calculation result S3.

At this time, the σ_{h (R+U)} of the equation (13) is obtained from the following equation (13a), and the σ_{R} of the equation (13) is obtained from the following equation (13b).

σ_{h(R+U)}={h(R+U)}^{d} mod n (13a)

σ_{R}:=R^{d} mod n (13b)

That is, the signature calculation result S3 is the remainder σ_{h (R+U)} obtained by dividing h (R+U) to the d-th power of the above equation (13a) by the parameter n, and the remainder σ_{R} obtained by dividing the d-th power of R in the above equation (13b) by the parameter n. The signature calculation result S3 has two of σ_{h (R+U)} and σ_{R}, and is transmitted to the SIP application 30b.

Next, the SIP application 30b performs the calculation of the above equation (14) to obtain the signature result S4.

That is, the signature result S4, in which the two values of the URI of the calling party A and the signature calculation result σ_{h (R+U)} are sets {U, σ_{h (R+U)}} is obtained. The signature result S4 is returned to the PKI server 22 as a response.

Next, the PKI server 22 verifies the signature result S4. That is, the PKI server 22 receives the set {U, ø_{h (R+U)}} of the signature result S4, calculates {σ_{h (R+U)}}^{e}, and from this calculation result, the remainder of dividing R to the dth power by the parameter n. If the value obtained by subtracting is the following equation (14a), which is U, it is verified that the signature is the signature of the calling party A himself/herself.

U≡{σ_{h(R+U)}}^{e}−R mod n (14a)

<Signature Method c>

S1=R+U (21)

S2=U,R+U (22)

S3=σ_{U},σ_{R+U} (23)

S4=(σ_{U},σ_{R+U}) (24)

This signature method c is a method that can be verified without using U for the signature result S4. Further, the hash function h is not used for S1 to S4. That is, the two values of the random number R and the URI are signed so that the signature and verification can be performed without using the hash function h.

The above equation (21) represents that the SIP application 30b calculates the sum of the random number R and the URI of A to obtain the signature object S1.

Next, the SIP application 30b calculates the signature object value S2 from each of the URI of A and the R+U calculated by the above equation (21) by the above equation (22). The signature object value S2 by the calculated U and R+U is transmitted to the IC chip 31a.

Next, the IC chip 31a performs the calculation of the above equation (23) according to the control of the SIP application 30b to obtain the signature calculation result S3.

At this time, the σ_{U} of the equation (23) is obtained from the following equation (23a), and the σ_{R+U} of the equation (23) is obtained from the following equation (23b).

σ_{U}:=U^{d} mod n (23a)

σ_{R+U}:=(R+U)^{d} mod n (23b)

That is, the remainder σ_{U} obtained by dividing the d-th power of U according to the above equation (23a) by the parameter n and the remainder σ_{R+U} obtained by dividing the d-th power of (R+U) according to the above equation (23b) by the parameter n are defined as the signature calculation result S3. That is, the signature calculation result S3 has two of σ_{U} and σ_{R+U}, and is transmitted to the SIP application 30b.

Next, the SIP application 30b performs the calculation of the above equation (24) to obtain the signature result S4.

That is, the signature result S4 paired the two values (σ_{U}, σ_{R+U}) of the first signature calculation result σ_{U}, and the second signature calculation result σ_{R+U} is obtained. The signature result S4 is returned to the PKI server 22 as a response.

Next, the PKI server 22 verifies the signature result S4. That is, the PKI server 22 receives the set (σ_{U}, σ_{R+U}) of the signature result S4, calculates σ_{U}^{e} and σ_{R+U}^{e}, and if the following equation (24a) is used, verifies that the signature is the signature of the calling party A himself/herself.

σ_{R+U}^{e}−σ_{U}^{e}≡R mod n (24a)

If each of σ_{R+U} and σ_{U} in the above equation (24a) is raised to the power by e, and then σ_{R+U}^{e}−σ_{U}^{e}, which is subtracted values from each other after raised to the power by e, and the remainder obtained by dividing the random number R by the parameter n are equal, it is verified that the signature is the signature of the calling party A himself/herself.

The signature methods a, b, and c described above all use the undecipherable RSA assumption. The signature methods a and b are premised on two RSA assumptions, and the signature method c is based on only one RSA assumption.

The RSA assumption is a mathematical assumption and represents one's own safety. However, it is a necessary condition to use a key that is so secure that the mathematical RSA encryption method cannot be cracked. Since it is uncertain whether such mathematical security can be achieved, we use assumptions.

The signature methods a and b are premised that two RSA assumptions hold true.

The signing method c assumes that there is only one RSA assumption.

The hash function h of the signature methods a and b is also called a unidirectional function, and although it is easy to calculate the output from the input, it is extremely difficult to restore the input from the output. In the case of a cryptosystem in which the hash function h is replaced by a random oracle assumption, this cryptosystem guarantees security under the random oracle assumption. That is, the random oracle assumption guarantees that the hash function h is safe.

Since the hash function h is not used in the signature method c, there is no possibility of recovering the input from the output, so that the security can be guaranteed.

In the signature calculation result S3 of the above-mentioned equation (3) and the signature result S4 of the equation (4), σ_{h (U)} can be reused and the number of operations after the second time can be reduced. That is, since the calculation raised to the power by d is not performed in the equations (3) and (4), the calculation raised to the power by d in the IC chip 31a can be reduced. σ_{h (U)} is a numerical value that does not need to be recalculated each time authentication is performed when the calculation of the URI once determined first and the hash function h already determined is performed. Therefore, once the URI is decided, the same calculation result will be obtained until the next URI is changed. Therefore, if σ_{h (U)} is calculated and stored, it can be used for the second and subsequent SIP telephones.

### Operation of Embodiment

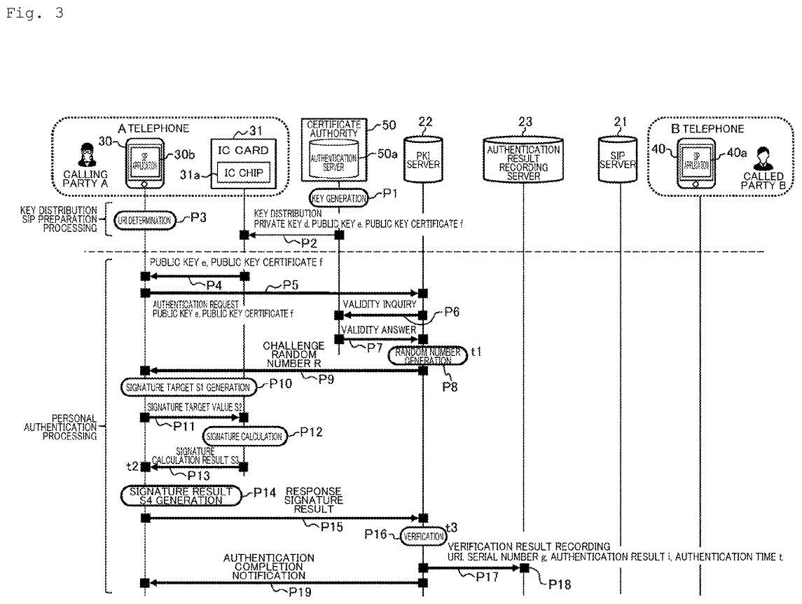

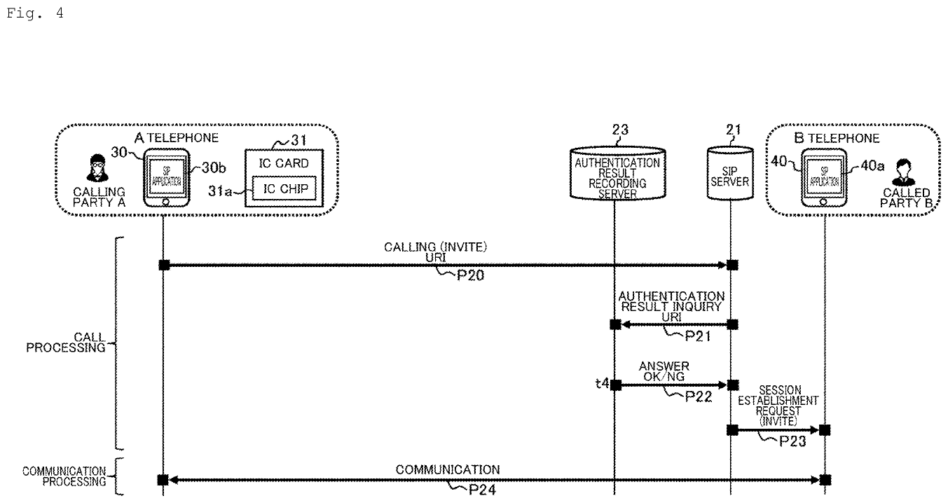

Next, the SIP telephone public key authentication operation in the SIP telephone public key authentication system 10 according to the present embodiment will be described with reference to the operation sequence diagrams of FIGS. 3 and 4.

### <Key Distribution and SIP Preparation Process>

In step P1 shown in FIG. 3, the authentication server 50a of the certificate authority 50 generates information of the private key d, the public key e, and the public key certificate f.

In step P2, the authentication server 50a transmits and distributes the generated private key d, public key e, and public key certificate f to the IC card 31 of the calling party A. The IC card 31 stores the private key d, the public key e, and the public key certificate f in the IC chip 31a.

In step P3, the calling party A determines the URI (URI of A) using the SIP application 30b of the telephone 30 A.

### <Personal Authentication Processing>

In step P4, the calling party A holds the IC card 31 in the vicinity of or in contact with the A telephone 30, and inputs the password number of the IC card 31 into the A telephone 30.

In this process, the public key e and the public key certificate f stored in the IC chip 31a are read by the SIP application 30b. The above-mentioned holding state needs to be continuously performed until the time t2 (described in FIG. 3) described later.

In step P5, the SIP application 30b transmits both the read public key e and the public key certificate f to the PKI server 22, and requests the PKI server 22 to authenticate the calling party A.

In step P6, the PKI server 22 inquires the authentication server 50a about the validity of the received public key certificate f.

In step P7, the authentication server 50a performs a process of confirming the validity of the public key certificate f according to the authentication information.

In this confirmation process, if the public key certificate f is invalid due to expiration or the like, the authentication server 50a returns the invalidity of the public key certificate f to the PKI server 22 in step P7. In this case, the personal authentication processing ends. On the other hand, if the public key certificate f is valid, the authentication server 50a returns the validity of the public key certificate f to the PKI server 22 in step P7.

In step P8, the PKI server 22 that received a valid answer generates a random number R. It is assumed that this generation time is t1 (described in FIG. 3). The time t1 and the times t2, t3, and t4 (described in FIGS. 3 and 4) described later are time management times for avoiding security risks.

In this example, the time t1-t3 is the valid time of the random number R for authentication, and the time t2-t4 is the valid time of the authentication result OK. In this way, if the valid time of the random number R and the valid time of the authentication result OK are not regulated, the association of the authenticated information may not be broken and an unnecessary attack may occur, which poses a security risk.

In step P9, the random number R generated in step P8 is returned to the SIP application 30b of the A telephone 30 that has made the authentication request. In other words, the PKI server 22 returns a challenge indicating signing using the random number R to the SIP application 30b.

The SIP application 30b that has received the random number R of this challenge performs signature processing in cooperation with the IC chip 31a. This signature processing is performed according to, for example, the signature method a in which one of the three types of signature methods a, b, and c described above is determined in advance.

In step P10, the SIP application 30b creates a signature object S1 from the received random number R and the URI determined in step P3, and then creates a signature object value S2. The created signature object value S2 is transmitted to the IC card 31 in step P11.

In step P12, the IC card 31 performs a signature calculation according to the above-determined signature method a using the signature object value S2. At the time of this signature calculation, the IC card 31 does not take out the private key d from the IC chip 31a, but performs the calculation of the above-mentioned equations (3), (3a) and (3b) in the IC chip 31a, and the signature calculation result S3.

In step P13, the IC card 31 returns the signature calculation result S3 to the SIP application 30b. Here, it is assumed that the time when the SIP application 30b finishes the signature process according to the received signature calculation result S3 is t2.

In step P14, the SIP application 30b creates the signature result S4 from the signature calculation result S3. In step P15, the signature result S4 is transmitted to the PKI server 22 as a response.

In step P16, the PKI server 22 verifies the signature result S4 according to the signature method a. As a result, it is assumed that the signature of the calling party A is verified. It is assumed that this verification time is t3.

The time t1-t3 is the valid time of the random number R for authentication.

In step P17, the PKI server 22 transmits the URI, the serial number g of the public key certificate f, the authentication result i, and the authentication time t3, which are the results of the above verification, to the authentication result recording server 23. In step P18, the recording server 23 records the verification result.

In step P19, the PKI server 22 notifies the A telephone 30 of the completion of authentication, and at this time, notifies that the authentication is OK or NG.

### <Call Processing>

In step P20 shown in FIG. 4, the SIP application 30b of the A telephone 30 makes a SIP call and makes a call (INVITE) to the B telephone 40 on the other side. INVITE is the first agreement information sent by SIP phone to establish a session. The URI of the calling party A is transmitted to the SIP server 21 together with this INVITE. However, the calling party A can also make a call to the B telephone 40 with the SIP application 30b using only the URI.

In step P21, the SIP server 21 that has received the INVITE inquires about the authentication result while sending the URI of the calling party A to the recording server 23 before connecting to the B telephone 40.

In step P22, the recording server 23 searches for the authentication result i corresponding to the received URI of A, and returns to the SIP server 21 whether the authentication result i is OK or NG. It is assumed that the time of this answer timing is t4. Time t2-t4 is the valid time of the authentication result OK.

In step P23, when the SIP server 21 receives an authentication OK response, it makes a session establishment request (INVITE) to the B telephone 40. Upon receiving this request, the B telephone 40 makes a call connection to the A telephone 30 in step P24.

### Effect of Embodiment

The effect of the SIP telephone public key authentication device 20 of such an embodiment will be described.

The authentication device 20 includes a SIP server 21, a PKI server 22, and an authentication result recording server 23 (also referred to as a recording server) that call and connect the A telephone 30 (calling party telephone) and a B telephone 40 (calling party telephone) using SIP, a SIP application 30b of the A telephone 30, and an IC card 31 having an IC chip 31a as a secret area are provided.

(1a) In the IC chip 31a, the IC card 31 stores the private key d, the public key e, and the public key certificate f of the calling party A using the A telephone 30 by SIP generated by the certificate authority 50 that authenticates a private key d, a public key d, and a public key.

The PKI server 22 receives the public key e and the public key certificate f from the A telephone 30, and when the result of inquiring the certificate authority 50 about the validity of the public key certificate f is answered as valid, the PKI server 22 generates the random number R, transmits the generated random number R to the A telephone 30, and after that, authenticates the calling party A by the linkage process with the SIP application 30b and the IC card 31.

The PKI server 22 receives the public key e and the public key certificate f from the A telephone 30, and when the result of inquiring the certificate authority 50 about the validity of the public key certificate f is answered as valid, the PKI server 22 generates the random number R, after the generated random number R is transmitted to the A telephone 30, the calling party A is authenticated by the linkage process with the SIP application 30b and the IC card 31.

Further, the SIP application 30b executes the signature calculation to be signed by the private key d in the IC chip 31a of the IC card 31 for each of the random number R from the PKI server 22, and the determined URI, and transmits the signature result obtained by the execution to the PKI server 22 together with the public key e and the public key certificate f read from the IC chip 31a.

Further, the PKI server 22 is configured to authenticate the calling party A by verifying the public key certificate f among the received signature result, the public key e and the public key certificate f using the public key e.

According to this configuration, the PKI server 22 generates a random number R after the private key d, the public key e, and the public key certificate f of the calling party A stored in the IC chip 31a of the IC card 31 are authenticated by the certificate authority 50, and then each of the random number R, and the URI determined by the SIP application 30b in response to the instruction of the calling party A is signed with the private key d in the IC chip 31a. Therefore, the mechanism is such that only the calling party A, who knows the private key d can properly sign. Further, since the private key d is stored in a secure IC chip 31a that cannot be read by a third party of the IC card 31, strong security is ensured so that the private key d cannot be stolen.

Therefore, the random number R generated by the PKI server 22 and the URI determined by the calling party A himself are signed with the private key d in the IC chip 31a that cannot be read by a third party, so that the calling party A can be authenticated while ensuring strong security not to be stolen by the thief.

(2a) the SIP application 30b calculates the signature object S1 by inputting U representing the URI into the hash function h by the linkage process with the IC card 31, obtains S1=h (U), and the signature object values S2=h (U) and R are obtained from each of the h (U) and the random number R.

Further, the SIP application 30b has a remainder σ_{h (U)} obtained by dividing h (U) to the d-th power by the parameter n defined by the public key e encryption method at verifying using the public key e, and R to the d-th power, which is divided by the parameter n, and the signature calculation result S3=σ_{h (U)}, σ_{R} is obtained from the remainder σ_{R}.

Further, the SIP application 30b sets three values of the U, the first signature calculation result σ_{h(U)} of S3, and the second signature calculation result σ_{R} to a set (U, σ_{h (U)}, σ_{R}), then, the signature result S4=(U, σ_{h (U)}, σ_{R}) is obtained, and the obtained signature result S4 is returned to the PKI server 22.

The PKI server 22 receives the signature result S4=(U, σ_{h (U)}, σ_{R}), and the remainder obtained by dividing the received {σ_{h (U)}}^{e} by n is equal to h (U), and the random number R, when the remainder obtained by dividing the parameter n by the parameter n is equal to the received σ_{R}^{e}, the signature is verified to be the signature of the calling party A himself/herself.

According to this configuration, the signature object h (U) is obtained by inputting the U representing the URI determined in response to the instruction of the calling party A in the SIP application 30b into the hash function h. The PKI server 22 verifies the signature result including the two signature calculation results relating to the h (U) and the random number R, and when both of the two signature calculation results satisfy the predetermined conditions, the calling party A It can be verified that it is the signature of the person. Therefore, it is possible to properly authenticate whether or not the signature result belongs to the calling party A himself/herself.

(3a) the SIP application 30b calculates the signature object S1 and the signature object value S2 by inputting the sum of the random number R and the U representing the URI into the hash function h by the linkage process with the IC card 31, and obtains S1=h (R+U) and S2=h (R+U). Further, the signature calculation result S3=σₕ(R+U), σ_{R} is obtained from the remainder σ_{h(R+U)} of dividing the d-th power of h(R+U) by parameter n that is defined by the public key e encryption method of verifying using the public key e, and the remainder σ_{R} of dividing the d-th power of R by the parameter n.

Further, the SIP application 30b sets two values of the U and the signature calculation result σ_{h (R+U)} of S3 to a set {U, σ_{h(R+U)}}, then, the signature result S4={U, σ_{h(R+U)}} is obtained, and the obtained signature result S4 is returned to the PKI server 22.

The PKI server 22 receives the signature result S4={U, σ_{h (R+U)}}, and the value obtained by subtracting the remainder obtained by dividing the random number R by the parameter n from the received {σ_{h (R+U)}}^{e} is equal to the URI, the configuration is such that the signature of the calling party A can be verified.

According to this configuration, the random number R and the U representing the URI determined according to the instruction of the calling party A in the SIP application 30b are input to the hash function h to obtain the signature object h (R+U). When the signature result including the signature calculation result, related to this h (R+U) and the random number R, is verified by the PKI server 22, and the value obtained by subtracting the remainder obtained by dividing the random number R by the parameter n from the signature calculation result is equal to the URI, it can be verified that the signature of the calling party A is the person himself/herself. Therefore, it is possible to properly authenticate whether or not the signature result belongs to the calling party A himself/herself.

(4a) The SIP application 30b calculates the signature object S1 by the sum of the random number R and the U representing the URI by the linkage process with the IC card 31, obtains S1=R+U, and signs from each of the R+U and the random number R, and finds the target values S2=U, R+U. Further, the signature calculation result S3=σ_{U}, σ_{R+U} is obtained from the remainder σ_{U} of dividing the d-th power of U by parameter n that is defined by the public key e encryption method of verifying using the public key e, and the remainder σ_{R+U} of dividing the d-th power of (R+U) by the parameter n.

Further, the SIP application 30b obtains the signature result S4=(σ_{U}, σ_{R+U}) by setting two values of Cu and σ_{R+U} as a pair (σ_{U}, σ_{R+U}), and returns the obtained signature result S4 to the PKI server 22.

The PKI server 22 receives the signature result S4=(σ_{U}, σ_{R+U}), and from received {σ_{h(R+U)}}^{e}, each of σ_{R+U}, σ_{U} is raised to the power by e, and when the value σ_{R+U}^{e}−σ_{U}^{e} obtained by subtraction between the values of power by e, and the remainder obtained by dividing the random number R by the parameter n are equal, the signature of the calling party A himself/herself can be verified.

According to this configuration, the two values for the random number R and the URI are signed without using the hash function h, and the signature result S4 is verified the signature of the calling party A himself/herself without using the URI. Therefore, since the hash function h is not used, there is no possibility of restoring the input from the output, and the security can be guaranteed by this amount.

(5a) A recording server 23 that records the verification result verified by the PKI server 22 in the DB 23, and a URI received at the time of making a SIP call from the A telephone 30 to the B telephone 40, and the received URI is transmitted to the recording server 23, further a SIP server 21 that transmits and inquires about the authentication result i in the verification result recorded in the DB 23, are included.

The recording server 23 searches for the verification result corresponding to the URI received at the time of the inquiry from the SIP server 21, and answers whether the authentication result i is valid or not to the SIP server 21, and the SIP server 21 gives a valid answer, when it was received, the A telephone 30 was configured to make a call connection to the B telephone 40.

According to this configuration, the personal authentication function of the calling party A by the PKI server 22 and the call connection function between the A telephone 30 and the B telephone 40 by the SIP server 21 can be separated, so that the SIP server 21 is an individual as in the conventional case, since it is not necessary to be involved in individual authentication, the load on the SIP server 21 can be reduced accordingly. Further, by separating the personal authentication flow processing of the PKI server 22 and the outgoing flow processing of the SIP server 21 in chronological order, it is possible to prevent a timeout from occurring in the outgoing flow processing even if the authentication processing takes a long time.

(6a) the time when the PKI server 22 generates the random number R is t1, the time when the SIP application 30b finishes executing the signature calculation is t2, and the time when the PKI server 22 verifies the signature of the calling party A is t3, and the time when the recording server 23 responds to the SIP server 21 whether or not the authentication result i is valid is t4.

In this case, the PKI server 22 performs processing by defining the time between time t1 and time t3 as the valid time of the random number R for authentication. The SIP server 21 and the recording server 23 are configured to perform processing by defining the time t2 and the time t4 as the valid time of the authentication result i.

According to this configuration, since the valid time of the random number R and the valid time of the authentication result i are regulated, it is possible to suppress a security risk that the authentication information is not linked and an unnecessary attack is received.

### Effect

(1) A public key authentication device, comprising:
an IC card for storing, in a secret area, a secret key, a public key and a public key certificate of a calling party related to a calling party telephone using SIP (Session Initiation Protocol) generated by a certificate authority that authenticates a secret key, a public key and a public key certificate; a SIP application for receiving an instruction from the calling party to determine a URI (Uniform Resource Identifier) of the calling party and causing the calling party telephone to execute control of transmitting a determined URI, a public key and a public key certificate read from the IC card; and a PKI (Public Key Infrastructure) server for receiving a public key and a public key certificate from the calling party telephone, generates a random number when a result of inquiry of validity of the public key certificate to the certificate authority is valid as answer, and authenticates the calling party after transmitting a generated random number to the calling party telephone, wherein the SIP application executes a signature calculation for causing each of a random number from the PKI server and the determined URI to sign with a secret key in a secret area of the IC card, transmits a signature result obtained by the execution to the PKI server together with a public key and a public key certificate read from the secret area, and the PKI server verifies the public key certificate by using the public key among a received signature result, a public key and a public key certificate, and authenticates a calling party.

According to this configuration, the PKI server generates the random number after the private key, the public key of the calling party, and the public key certificate that are stored in the secret area of the IC card are authenticated by the certificate authority, and the SIP application signs for each of this random number, and the URIs determined by receiving the instruction from the calling party with the private key in the secret area. For this reason, the mechanism is such that only the calling party who knows the private key can properly sign. Further, since the private key is stored in a secure secret area that cannot be read by a third party of the IC card, strong security is ensured so that the private key cannot be stolen.

For this reason, the random number generated by the PKI server and the URI determined by the calling party himself are signed with the private key in the secret area that cannot be read by a third party, so that the thief cannot steal it, and perform authentication of the calling party while ensuring good security. Therefore, after making a call using the URI on the calling party A telephone 30, and before making a call connected to the other party's B telephone 40, the URI of the calling party A and the authentication information of the calling party A are properly linked to each other, and the calling party can be authenticated.

(2) the SIP application calculates S1 to be signed by inputting U representing the URI into the hash function h as the signature calculation to obtain S1=h (U), and the h (U) and the said, the signature object values S2=h (U) and R are obtained from each of the random numbers R, and the d-th power of the h (U) is verified by the parameter n defined by the public key cryptosystem when the public key is used, the signature calculation results S3=σ_{h (U)}, σ_{R} are obtained from the remainder σ_{h (U)} divided and the remainder σ_{R} obtained by dividing the random number R to the dth power by the parameter n, and the U and the first of the S3 are obtained, the signature result S4=(U, σ_{h (U)}, σ_{R}) by setting the three values of the first signature calculation result σ_{h (U)} and the second signature calculation result σ_{R} as a set (U, σ_{h (U)}, σ_{R}), the requested signature result S4 is returned to the PKI server, and the PKI server receives the signature result S4=(U, σ_{h (U)}, σ_{R}) and receives {σ_{h (U)}}^{e}, when the remainder divided by n is equal to the h (U) and the remainder obtained by dividing the random number R by the parameter n is equal to the received σ_{R}^{e}, it is verified that the signature is the signature of the calling party himself/herself, the public key authentication device according to (1) above.

According to this configuration, the signature object h (U) is obtained by inputting the U representing the URI determined by receiving the instruction from the calling party in the SIP application into the hash function h. The signature result including the two signature calculation results related to h (U) and the random number R is verified by the PKI server, and when both of the two signature calculation results satisfy the predetermined conditions, the calling party himself/herself It can be verified as a signature. Therefore, it is possible to properly authenticate whether or not the signature result belongs to the sender.

(3) The SIP application as the signature calculation calculates a signature target S1 and a signature target S2 are calculated by inputting a sum of the random number R and U representing the URI to a hash function h, and S1=h(R+U) and S2=h(R+U) are obtained, a signature calculation result S3=σ_{h(R+U)}, σ_{R} is obtained from a remainder σ_{h(U)} obtained by dividing the d-th power of the h (R+U) by a parameter n defined by a public key cryptosystem when verifying using the public key and a remainder σ_{R} obtained by dividing the d-th power of the random number R by the parameter n, two values of the U and σ_{h(R+U)} of the signature calculation result S3 are set to a set {U, σ_{h(R+U)}}, and the signature result S4={U, σ_{h(R+U)}} is obtained, this obtained a signature result S4 is returned to the PKI server, the PKI server receives the signature result S4={U, σ_{h(R+U)}}, and when a value that is obtained by subtracting the remainder obtained by dividing the random number R by a parameter n from a received {σ_{h(R+U)}}^{e} is equal to the URI, the signature of the calling party himself/herself is verified.

According to this configuration, the random number R and the U representing the URI determined by receiving the instruction from the calling party in the SIP application are input to the hash function h to obtain the signature object h (R+U). When the signature result including this h (R+U) and the signature calculation result related to the random number R is verified by the PKI server, and the value obtained by subtracting the remainder obtained by dividing the random number R by the parameter n from the signature calculation result is equal to the URI. It can be verified that it is the signature of the sender himself/herself. Therefore, it is possible to properly authenticate whether or not the signature result belongs to the sender.

(4) The public key authentication device above described (1), wherein the SIP application as the signature calculation calculates a signature target S1 is calculated from a sum of the random number R and U representing the URI, and S1=R+U is obtained, a signature target value S2=U, R+U is obtained from each of the R+U and the random number R, a signature calculation result S3=σ_{U}, σ_{R+U} is obtained from a remainder σ_{U} obtained by dividing the d-th power of the U by a parameter n defined by a public key cryptosystem when verifying using the public key and a remainder σ_{R+U} obtained by dividing the d-th power of the (R+U) by a parameter n, two values of the σ_{U} and the σ_{R+U} are set to a set (σ_{U}, σ_{R+U}), and a signature result S4=(σ_{U}, σ_{R+U}) is obtained, this obtained signature result S4 is returned to the PKI server, the PKI server receives the signature result S4=(σ_{U}, σ_{R+U}), and the e-th power of each σ_{R+U} and σ_{U} from a received {σ_{h(R+U)}}^{e} is performed, and when a value σ_{R+U}^{e}−σ_{U}^{e} obtained by subtraction between values after e-th power, and a remainder obtained by dividing a random number R by a parameter n are equal, a signature of a calling party A himself/herself can be verified.

According to this configuration, the two values of the random number R and the URI are signed without using the hash function h, and the signature result S4 is verified to be the signature of the calling party himself/herself without using the URI. Therefore, since the hash function h is not used, there is no possibility of restoring the input from the output, and the security can be guaranteed by this amount.

(5) A recording server that records the verification results verified by the PKI server in a DB (Data Base), and the URI that is received and received at the time of making a SIP call from the calling party telephone to the called party telephone. Is further provided with a SIP server that inquires about the authentication result in the verification result recorded in the DB by transmitting to the recording server, and the recording server corresponds to the verification result received at the time of the inquiry from the SIP server. Is searched, and whether or not the authentication result is valid is answered to the SIP server, and when the SIP server receives the valid answer, the calling party telephone is connected to the called party telephone by a call. The public key authentication device according to any one of (1) and (4) above.

According to this configuration, the personal authentication function of the calling party by the PKI server and the call connection function between the calling party telephone and the called side telephone by the SIP server can be separated. Therefore, since the SIP server does not have to be involved in personal authentication as in the conventional case, the load on the SIP server can be reduced accordingly. Further, by separating the personal authentication flow processing of the PKI server and the outgoing flow processing of the SIP server in chronological order, it is possible to prevent a timeout from occurring in the outgoing flow processing even if the authentication processing takes a long time.

(6) The public key authentication device above described (5), wherein in the case that a time when the PKI server generated a random number is defined as t1, a time when the SIP application finishes executing the signature calculation is defined as t2,

a time when the PKI server verifies a signature of a calling party himself/herself is defined as t3, and when a time at which the recording server replies the SIP server as to whether the authentication result is valid or not is defined as T4, the PKI server performs processing by defining a period between the time t1 and the time t3 as a valid time of a random number for authentication, and the SIP server and the recording server determine between the time t2 and the time t4 as a valid time of an authentication result and perform processing.

According to this configuration, since the valid time of the random number and the valid time of the authentication result are regulated, it is possible to suppress the security risk that the authentication information is not linked and an unnecessary attack is received.

In addition, the specific configuration can be appropriately changed without departing from the gist of the present invention.

### REFERENCE SIGNS LIST

10 SIP telephone public key authentication system
20 SIP telephone public key authentication device (public key authentication device)
21 SIP server
22 PKI server
23 Authentication result recording server
30 A telephone (calling party telephone)
30a IC card control unit
30b SIP application
31 IC card
31a IC chip
40 B telephone (calling party telephone)
50 Certificate authority
50a Authentication server

1. A public key authentication device, comprising:
an IC card for storing, in a secret area, a secret key, a public key and a public key certificate of a calling party related to a calling party telephone using SIP (Session Initiation Protocol) generated by a certificate authority that authenticates a secret key, a public key and a public key certificate;
a SIP application for receiving an instruction from the calling party to determine a URI (Uniform Resource Identifier) of the calling party and causing the calling party telephone to execute control of transmitting a determined URI, a public key and a public key certificate read from the IC card; and
a PKI (Public Key Infrastructure) server for receiving a public key and a public key certificate from the calling party telephone, generates a random number when a result of inquiry of validity of the public key certificate to the certificate authority is valid as answer, and authenticates the calling party after transmitting a generated random number to the calling party telephone, wherein
the SIP application executes a signature calculation for causing each of a random number from the PKI server and the determined URI to sign with a secret key in a secret area of the IC card, transmits a signature result obtained by the execution to the PKI server together with a public key and a public key certificate read from the secret area, and
the PKI server verifies the public key certificate by using the public key among a received signature result, a public key and a public key certificate, and authenticates a calling party.

2. The public key authentication device according to claim 1, wherein
the SIP application as the signature calculation calculates a signature target S1 by inputting U representing the URI to a hash function h, and S1=h(U) is obtained,
a signature target value S2=h(U), R is obtained from each of the h(U) and the random number R,
a signature calculation result S3=σ_{h(U)}, σ_{R} is obtained from a remainder σ_{h(U)} obtained by dividing a d-th power of the h(U) by a parameter n defined by a public key cryptosystem when verifying using the public key and a remainder aa obtained by dividing the d-th power of the random number R by a parameter n, three values of the U, a first signature calculation result σ_{h(U)} of the S3, and a second signature calculation result σ_{R} are set to a set (U, σ_{h(U)}, σ_{R}), and the signature result S4=(U, σ_{h(U)}, σ_{R}) is obtained, this obtained signature result S4 is returned to the PKI server,
the PKI server receives a signature result S4=(U, σ_{h(U)}, σ_{R}), and a remainder obtained by dividing a received {σ_{h(U)}}^{e} by the parameter n is equal to the h(U), and a remainder obtained by dividing the random number R by a parameter n is equal to the received σ_{R}^{e},
a signature of the calling party is verified.

3. The public key authentication device according to claim 1, wherein
the SIP application as the signature calculation calculates a signature target S1 and a signature target S2 are calculated by inputting a sum of the random number R and U representing the URI to a hash function h, and S1=h(R+U) and S2=h(R+U) are obtained,
a signature calculation result S3=σ_{h(R+U)}, aa is obtained from a remainder σ_{h(R+U)} obtained by dividing a d-th power of the h(R+U) by a parameter n defined by a public key cryptosystem when verifying using the public key and a remainder aa obtained by dividing the d-th power of the random number R by the parameter n,
two values of the U and σ_{h(R+U)} of the signature calculation result S3 are set to a set {U, σ_{h(R+U)}}, and the signature result S4={U, σ_{h(R+U)}} is obtained, this obtained a signature result S4 is returned to the PKI server,
the PKI server receives the signature result S4={U, σ_{h(R+U)}}, and when a value that is obtained by subtracting the remainder obtained by dividing the random number R by a parameter n from a received {σ_{h(R+U)}} is equal to the URI,
the signature of the calling party is verified.

4. The public key authentication device according to claim 1, wherein
the SIP application as the signature calculation calculates a signature target S1 is calculated from a sum of the random number R and U representing the URI, and S1=R+U is obtained,
a signature target value S2=U, R+U is obtained from each of the R+U and the random number R,
a signature calculation result S3=α_{U}, σ_{R+U} is obtained from a remainder σ_{U} obtained by dividing a d-th power of the U by a parameter n defined by a public key cryptosystem when verifying using the public key and a remainder σ_{R+U} obtained by dividing the d-th power of the (R+U) by a parameter n,
two values of the σ_{U} and the σ_{R+U} are set to a set (σ_{U}, σ_{R+U}), and a signature result S4=(σ_{U}, σ_{R+U}) is obtained, this obtained signature result S4 is returned to the PKI server,
the PKI server receives the signature result S4=(σ_{U}, σ_{R+U}), and the e-th power of each σ_{R+U} and σ_{U} from a received {σ_{h(R+U})}^{e} is performed, and when a value σ_{R+U}^{e}−σ_{U}^{e} obtained by subtraction between values after e-th power, and a remainder obtained by dividing a random number R by a parameter n are equal,
a signature of a calling party can be verified.

5. The public key authentication device according to claim 4, compromising:
a recording server for recording a verification result verified by the PKI server in a DB (Data Base) query data base; and
a SIP server that receives the URI at a time of making a SIP call from the calling party telephone to a called party telephone, transmits a received URI to the recording server, and inquires of an authentication result in a verification result recorded in the DB,
wherein
the recording server searches for a verification result corresponding to a URI received at a time of inquiry from the SIP server, answers to the SIP server whether or not an authentication result is valid, and
the SIP server connects the calling party telephone to the called party telephone when receiving the valid answer.

6. The public key authentication device according to claim 5, wherein
in a time when the PKI server generated a random number is defined as t1,
a time when the SIP application finishes executing the signature calculation is defined as t2,
a time when the PKI server verifies a signature of a calling party himself/herself is defined as t3,
and when a time at which the recording server replies the SIP server as to whether the authentication result is valid or not is defined as T4,
the PKI server performs processing by defining a period between the time t1 and the time t3 as a valid time of a random number for authentication, and
the SIP server and the recording server determine between the time t2 and the time t4 as a valid time of an authentication result and perform processing.

7. A public key authentication method in a configuration including an IC card, a SIP application of a calling party telephone, and PKI server, a public key authentication method performing:
a storing, by an IC card, a secret key, a public key and a public key certificate of a calling party related to a calling party telephone using SIP generated by a certificate authority that authenticates a secret key, a public key and a public key certificate in secret area of the IC card;
receiving, by the SIP application, an instruction from the calling party to determine a URI of the calling party and causes the calling party telephone to execute control of transmitting a determined URI, a public key and a public key certificate read from the IC card;
receiving, by the PKI server, a public key and a public key certificate from the calling party telephone;
generating, by the PKI server, a random number when a result of inquiry of validity of a public key certificate to the certificate authority is valid as answer;
transmitting, by the PKI server, a generated random number to the calling party telephone;
executing, by the SIP application, a signature calculation for causing each of a random number from the PKI server and the determined URI to sign with a secret key in a secret area of the IC card;
transmitting, by the SIP application, a signature result obtained by execution to the PKI server together with a public key and a public key certificate read from a secret area; and
verifying, by the PKI server, the public key certificate by using the public key among a received signature result, a public key and a public key certificate, and
authenticating a calling party.

8. The public key authentication method according to claim 7, further comprising:
calculating, by the SIP application as the signature calculation, a signature target S1 by inputting U representing the URI to a hash function h, and S1=h(U) is obtained;
obtaining, by the SIP application, a signature target value S2=h(U), R is obtained from each of the h(U) and the random number R;
obtaining, by the SIP application, a signature calculation result S3=σ_{h(U)}, σ_{R} from a remainder σ_{h(U)} obtained by dividing a d-th power of the h(U) by a parameter n defined by a public key cryptosystem when verifying using the public key and a remainder aa obtained by dividing the d-th power of the random number R by a parameter n, three values of the U, a first signature calculation result σ_{h(U)} of the S3, and a second signature calculation result σ_{R} are set to a set (U, σ_{h(U)}, σ_{R}), and the signature result S4=(U, σ_{h(U)}, σ_{R}) is obtained, this obtained signature result S4 is returned to the PKI server;
receiving, by the PKI server, a signature result S4=(U, σ_{h(U)}, σ_{R}), and a remainder obtained by dividing a received {σ_{h(U)}}^{e} by the parameter n is equal to the h(U), and a remainder obtained by dividing the random number R by a parameter n is equal to the received σ_{R}^{e}; and
verifying a signature of the calling party.

9. The public key authentication method according to claim 7, further comprising:
calculating, the SIP application as the signature calculation, a signature target S1 and a signature target S2 by inputting a sum of the random number R and U representing the URI to a hash function h, and S1=h(R+U) and S2=h(R+U) are obtained,
obtaining, by the SIP application, a signature calculation result S3=σ_{h(R+U)}, σ_{R} from a remainder σ_{h(R+U)} obtained by dividing a d-th power of the h(R+U) by a parameter n defined by a public key cryptosystem when verifying using the public key and a remainder aa obtained by dividing the d-th power of the random number R by the parameter n;
setting, by the SIP application, two values of the U and σ_{h(R+U)} of the signature calculation result S3 to a set {U, σ_{h(R+U)}}, and the signature result S4={U, σ_{h(R+U)}} is obtained;
returning, by the SIP application, the obtained signature result S4 to the PKI server;
receiving, by the PKI server, the signature result S4={U, σ_{h(R+U)}}; and
verifying the signature of the calling party when a value that is obtained by subtracting the remainder obtained by dividing the random number R by a parameter n from a received {σ_{h(R+U)}}^{e} is equal to the URI.

10. The public key authentication method according to claim 7, further comprising:
calculating, by the SIP application as the signature calculation, a signature target S1 from a sum of the random number R and U representing the URI, and S1=R+U is obtained, a signature target value S2=U, R+U is obtained from each of the R+U and the random number R;
obtaining, by the SIP application, a signature calculation result S3=σ_{U}, σ_{R+U} from a remainder σ_{U} obtained by dividing a d-th power of the U by a parameter n defined by a public key cryptosystem when verifying using the public key and a remainder σ_{R+U} obtained by dividing the d-th power of the (R+U) by a parameter n,
setting, by the SIP application, two values of the σ_{U} and the σ_{R+U} to a set (σ_{U}, σ_{R+U}), and a signature result S4=(σ_{U}, σ_{R+U}) is obtained;
returning, by the SIP application, the obtained signature result S4 to the PKI server;
receiving, by the PKI server, the signature result S4=(σ_{U}, σ_{R+U}); and
verifying a signature of a calling party when the e-th power of each σ_{R+U} and σ_{U} from a received {σ_{h(R+U)}}^{e} is performed, and when a value σ_{R+U}^{e}−σ_{U}^{e} is obtained by subtraction between values after e-th power, and a remainder obtained by dividing a random number R by a parameter n are equal.

11. The public key authentication method according to claim 10, further comprising:
recording, by a recording server, a verification result verified by the PKI server in a DB (Data Base) query data base;
receiving, by an SIP server, the URI at a time of making a SIP call from the calling party telephone to a called party telephone;
transmitting, by the SIP server, a received URI to the recording server;
inquiring, by the SIP server, of an authentication result in a verification result recorded in the DB;
searching, by the recording server, for a verification result corresponding to a URI received at a time of inquiry from the SIP server;
answering, by the recording server, to the SIP server whether or not an authentication result is valid; and
connecting, by the SIP server, the calling party telephone to the called party telephone when receiving the valid answer.

12. The public key authentication method according to claim 11, wherein:
in a time when the PKI server generated a random number is defined as t1,
a time when the SIP application finishes executing the signature calculation is defined as t2,
a time when the PKI server verifies a signature of a calling party himself/herself is defined as t3,
and when a time at which the recording server replies the SIP server as to whether the authentication result is valid or not is defined as T4;
performing, by the PKI server, processing by defining a period between the time t1 and the time t3 as a valid time of a random number for authentication, and
determining, by the SIP server and the recording server, between the time t2 and the time t4 as a valid time of an authentication result and perform processing.
